(19) United States
(12) Patent Application Publication
(10) Pub. No.: US 2005/0204090 A1
(43) Pub. Date: Sep. 15, 2005

(54) Hardware stack for blocked nonvolatile memories

(76) Inventor: Sean S. Eilert, Penryn, CA (US)

Correspondence Address: INTEL CORPORATION, P.O. BOX 5326, SANTA CLARA, CA, 95056-5326, US

(21) Appl. No.: 10/798,641

(22) Filed: Mar. 10, 2004

(51) Int. Cl. G06F 12/00

(52) U.S. Cl. 711/103; 711/154

(57) ABSTRACT

A nonvolatile stack configured within a nonvolatile memory.

It is common, in computing systems, that small data structures be stored in nonvolatile memory space and be updated frequently. Due to the blocked architecture of nonvolatile memory, a problem arises when data structures are significantly smaller than the size of a memory block. Both valid and invalid fragments are typically managed in one or more memory blocks, with the smallest block available usually selected to minimize any wasted nonvolatile memory space. However, selecting the smallest available block may be optimal to minimize the space overhead but this creates a worst-case use condition for cycling based on an increase in the number of program/erase cycles for these small blocks. Accordingly, there is a need to implement a design that manages nonvolatile memory space and provides memory cycle management to improve system performance.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates features of the present invention for a stack that may be incorporated into a nonvolatile memory;

FIG. 2 illustrates operation of the stack configured within the nonvolatile memory illustrated in FIG. 1;

FIG. 3 shows one embodiment of the nonvolatile memory in accordance with the present invention; and

FIG. 4 describes operating features of the stack located within the nonvolatile memory in accordance with the present invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

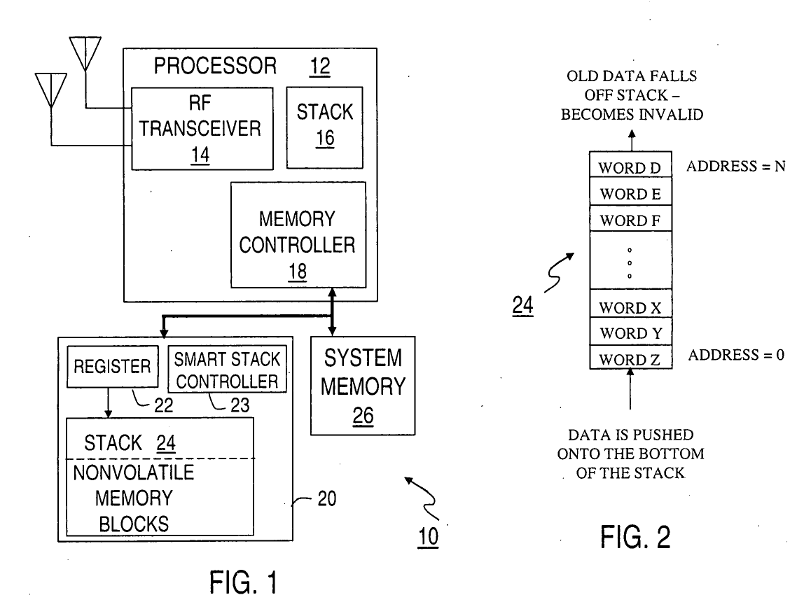

FIG. 1 illustrates features of the present invention that may be incorporated, for example, into a wireless communications device 10, although this is not a limitation of the present invention. In the wireless communications embodiment, a transceiver 14 both receives and transmits a modulated signal from one or more antennas. The analog front end transceiver may be a stand-alone Radio Frequency (RF) integrated analog circuit, or alternatively, be embedded with a processor 12 as a mixed-mode integrated circuit. The received modulated signal is frequency down-converted, filtered, then converted to a baseband, digital signal.

Processor 12 may include baseband and applications processing functions, and in general, be capable of fetching instructions, generating decodes, finding operands, performing the appropriate actions and storing results. Processor 12 may include a volatile stack 16. The digital data processed by processor 12 may be transferred, under the control of a memory controller 18, across an interface for storage by a system memory 26. A nonvolatile memory 20 may be connected via a bus to processor 12 which may be controlled by memory controller 18, although this is not a limitation of the present invention.

Nonvolatile memory 20 may include a register 22 that holds, among other things, an offset value for a nonvolatile stack 24 configured in the nonvolatile memory. In accordance with the present invention, stack 24 retains nonvolatile stack parameter values in a nonvolatile memory. In some embodiments, nonvolatile memory 20 may be an Electrically Programmable Read-Only Memory (EPROM), an Electrically Erasable and Programmable Read Only Memory (EEPROM), NOR or NAND Flash memory, a Ferroelectric Random Access Memory (FRAM), a Polymer Ferroelectric Random Access Memory (PFRAM), a Magnetic Random Access Memory (MRAM), a MicroElectroMechanical System (MEMS) memory, an Ovonics Unified Memory (OUM) or any other device capable of storing instructions and/or data. However, it should be understood that the scope of the present invention is not limited to these examples. Note that for some embodiments the flash memory cells may be a single-bit-per-cell structure that allows a single bit of information to be stored in each cell or a multi-level cell structure allowing two or more bits of information to be stored in a single transistor.

In the polymer memory embodiment, nonvolatile memory 20 may include ferroelectric memory cells, wherein each cell includes a ferroelectric polymer material located between at least two conductive lines. The ferroelectric polymer material may be a ferroelectric polarizable material and include a ferroelectric polymer material comprised of a polyvinyl fluoride, a polyethylene fluoride, a polyvinyl chloride, a polyethylene chloride, a polyacrylonitrile, a polyamide, copolymers thereof, or combinations thereof. Nonvolatile memory 20 may further include chalcogenide memory devices or microelectromechanical (MEM) memory devices.

In an alternate embodiment where nonvolatile memory 20 may be a polymer memory such as, for example, a plastic memory or a resistive change polymer memory, the plastic memory may include a thin film of polymer memory material sandwiched at the nodes of an address matrix. The resistance at any node may be altered from a few hundred ohms to several megohms by an electric potential supplied across the polymer memory material and a positive or negative current flowing in the polymer material that alters the resistance of the polymer material. Potentially, different resistance levels may store several bits per cell and data density may be increased further by stacking layers.

Embodiments of the present invention for a nonvolatile memory 20 may be used in a variety of applications, with the claimed subject matter incorporated into microcontrollers, general-purpose microprocessors, Digital Signal Processors (DSPs), Reduced Instruction-Set Computing (RISC), Complex Instruction-Set Computing (CISC), among other electronic components. In particular, the present invention that includes locating a stack structure within a nonvolatile memory may be used in smart phones to provide temporary storage for frequency and time slot information. In addition, the present invention may be used in communicators and Personal Digital Assistants (PDAs), medical or biotech equipment, automotive safety and protective equipment, and automotive infotainment products. However, it should be understood that the scope of the present invention is not limited to these examples.

FIG. 2 illustrates an embodiment of stack 24 that receives addresses to address words stored in the nonvolatile memory. Stack 24 provides storage for N+1 parameter values addressable by an address that ranges from ADDRESS=N to ADDRESS=0. Note that the stack depth “N+1” of stack 24 may be preset by the Flash manufacturer. Alternatively, the stack depth may be a parameter that is configurable through software by the system designer.

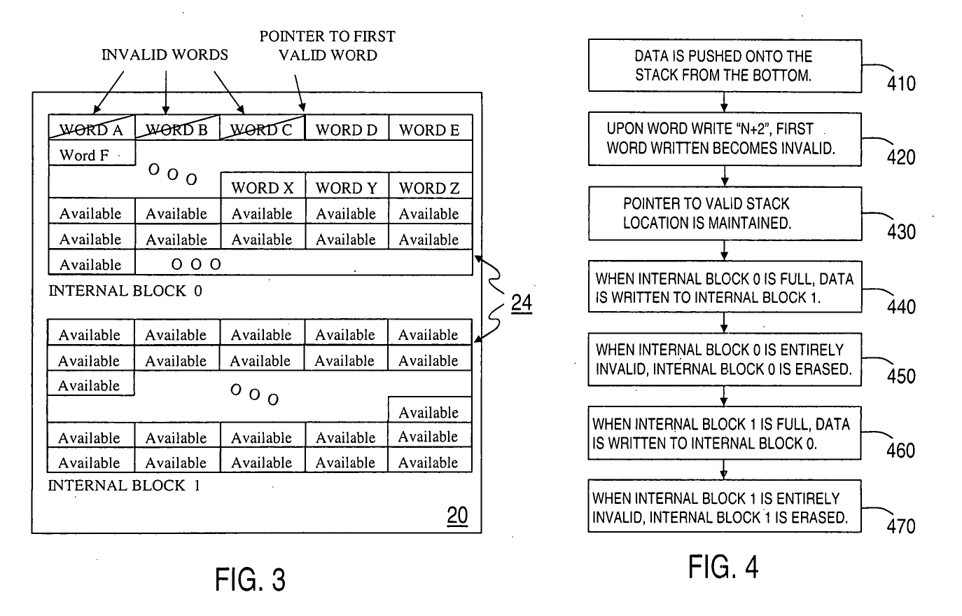

FIG. 3 shows an embodiment of nonvolatile memory 20 that for ease of description is shown as having one memory block pair, e.g. memory blocks INTERNAL BLOCK 0 and INTERNAL BLOCK 1, although it should be noted that the number of memory block pairs is not a limitation of the present invention. Valid stack data may be stored in INTERNAL BLOCK 0 and INTERNAL BLOCK 1, with the size of the memory pool that stores the stack contents optimized by the Flash manufacturer to balance the manufacturer's cycling and data retention capabilities with the desired maximum writes specification. The manufacturer may choose an appropriately large memory array in which to implement the stack and therefore provide the opportunity to limit block cycles induced during parameter manipulation.

Nonvolatile memory 20 is shown as external to processor 12, but in one embodiment may be integrated with the processor. Nonvolatile memory 20 includes a register 22 that may be instantiated with an offset data value for stack 24 in nonvolatile memory 20. Nonvolatile memory 20 may also include a smart stack controller 23 to dynamically determine the number of blocks used in the stack and distribute write cycles across the multiple blocks. When stack 24 is written, the address in the offset register may be incremented and data written into the selected memory block. Processor 12 provides an address to nonvolatile memory 20, that address is added to the offset value stored in register 22, and that summed value is further added to the length of the stack to provide the appropriate address used in stack 24. Thus, processor 12 simply provides an address to nonvolatile memory 20 and the nonvolatile memory translates that address into the appropriate address for reading/writing parameter values from/to stack 24.

By way of example, processor 12 may provide an address of 0 that indicates the address for writing a current word, i.e., WORD Z, into nonvolatile memory 20. The address of 0 is added to the offset value, with the summed result further added to the stack depth of “N+1” to provide the desired address for locating WORD Z in the stack. On the other hand, when stack 24 is read, the offset register may be inspected, the appropriate address read and the resulting data returned to the user. Note that prior written items become unavailable to the user as new data values are placed on the stack. Further note that various methods may be used to locate valid parameter values, one method involving scanning the memory block for the last valid data entry and another method that updates and maintains a pointer to the valid data.

FIG. 4 describes operating features of the nonvolatile memory in accordance with the present invention. Block 410 describes data pushed onto the stack from the bottom of stack 24. For an internal block of nonvolatile memory sized to store from 0 to N data words, block 420 indicates that when the parameter value in WORD “N+2” is written, the data in WORD 0 is invalid. Block 430 shows that that the address in the offset register is incremented when stack 24 is written and that the pointer to a valid stack location is maintained. Block 440 indicates that when INTERNAL BLOCK 0 is full, data may then be written to INTERNAL BLOCK 1. Block 450 indicates that when INTERNAL BLOCK 0 is entirely invalid, INTERNAL BLOCK 0 may then be erased. Block 460 indicates that when INTERNAL BLOCK 1 is full, data may then be written to INTERNAL BLOCK 0. Block 470 indicates that when INTERNAL BLOCK 1 is entirely invalid that INTERNAL BLOCK 1 may then erased.

In operation and briefly referring to FIG. 3, data may be pushed onto the bottom of stack 24 by storing data as WORD Z in the INTERNAL BLOCK 0 of nonvolatile memory 20. Subsequent data writes may be sequentially stored in that memory block, with each write invalidating data from a prior write. By way of example, after writing WORD Z, the data WORD C is invalid. Note that prior writes have already invalidated the data in WORD A and WORD B.

When the data words in INTERNAL BLOCK 0 are full, data may be written to INTERNAL BLOCK 1. Further, when “N+1” data words have been written in INTERNAL BLOCK 1 and that block is full, INTERNAL BLOCK 0 may be erased since the data words in INTERNAL BLOCK 0 are invalid. Continuing with data writes causes INTERNAL BLOCK 1 to fill, data may then be written to INTERNAL BLOCK 0, and INTERNAL BLOCK 1 may be erased.

By now it should be apparent that features of the present invention enhance accessing a stack within a nonvolatile memory. The Flash manufacturer may ensure that extremely volatile data that requires relatively little retention time is not mixed with low cycle data that may require very long retention times. Further, system performance may be improved as well as system power by restricting or confining searches to one memory block for the last stored value within the Flash device.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A stack configured in a nonvolatile memory to store parameter values.

2. The stack of claim 1 wherein the nonvolatile memory includes a pair of blocks that are erased independently.

3. The stack of claim 2 wherein valid parameter values are stored in a first block of the pair of blocks and a second block is erased.

4. The stack of claim 3 wherein valid parameter values are stored in the second block of the pair of blocks and the first block is erased.

5. The stack of claim 1 further including a register to store an offset value used to generate an address for words in the nonvolatile memory.

6. The stack of claim 1 further including a smart stack controller to dynamically determine a number of blocks used in the stack.

7. The stack of claim 1 further including a smart stack controller to distribute write cycles across multiple blocks of the nonvolatile memory.

8. The stack of claim 1 wherein the nonvolatile memory includes polymer memory devices.

9. The stack of claim 8 wherein the polymer memory devices are plastic memory devices.

10. The stack of claim 8 wherein the polymer memory devices are resistive change polymer memory devices.

11. A nonvolatile stack to store parameter values in words of a nonvolatile memory.

12. The nonvolatile stack of claim 11, wherein a memory pool in at least first and second blocks of the nonvolatile memory are sized to balance cycling and data retention capabilities with a write specification.

13. The nonvolatile stack of claim 11, further including a stack controller to distribute write cycles across multiple blocks of the nonvolatile memory.

14. The nonvolatile stack of claim 11, wherein the nonvolatile memory maps a received address to determine memory blocks to be written.

15. A storage device, comprising:
a nonvolatile memory having multiple blocks in a dynamic block swapped architecture, wherein a pair of blocks are configured to provide a first stack that stores parameter values.

16. The storage device of claim 15 further including a smart stack controller to distribute write cycles across the multiple blocks.

17. The storage device of claim 15 further including a smart stack controller to dynamically determine which blocks from the multiple blocks are used in the first stack.

18. The storage device of claim 15 wherein a second pair of blocks are instantiated in the storage device to configure a second stack.

19. The storage device of claim 15 wherein multiple stacks are instantiated in the storage device with two blocks shared among the multiple stacks.

20. A computer system, comprising:
first and second antennas;
a transceiver coupled to the first and second antennas;
a processor coupled to the transceiver; and
a nonvolatile memory coupled to the processor to provide a nonvolatile stack to store parameter values.

21. The computer system of claim 20 wherein the nonvolatile memory includes first and second blocks that are configured to form the nonvolatile stack and are erased independently.

22. The computer system of claim 20 further including a register to store an offset value used to generate an address for words in the nonvolatile memory.

23. The computer system of claim 20 where the nonvolatile stack includes polymer memory devices.

24. The computer system of claim 20 where the nonvolatile stack includes Chalcogenide memory devices.

25. The computer system of claim 20 where the nonvolatile stack includes microelectromechanical (MEM) memory devices.

26. A method comprising:
configuring a stack in first and second blocks of a nonvolatile memory; and
pushing data onto the stack.

27. The method of claim 26, further including:
receiving an address from a processor that is translated by the nonvolatile memory to an address location for storing parameter values in the first and second blocks.

28. The method of claim 26, further including:
writing data to a second memory block of the nonvolatile memory when a first memory block is full.

29. The method of claim 28, further including:
erasing the first memory block when the data stored in the first memory block is entirely invalid.

30. The method of claim 26, further including:
scanning for a last valid data entry by confining searches to one memory block for a last stored value within the nonvolatile memory.

31. The method of claim 26, further including:
reading the data at an address determined based on register contents and a processor-supplied address.
